(19) United States
(12) Patent Application Publication
(10) Pub. No.: US 2013/0211906 A1
(43) Pub. Date: Aug. 15, 2013

(54) Measuring and Utilizing The Effect of Social Sharing In Online Advertising

(71) Applicants: Ashish Sumant, Mountain View, CA (US); Lei Tang, Santa Clara, CA (US); Kun Liu, Sunnyvale, CA (US); Wanlin Pang, Sunnyvale, CA (US)

(72) Inventors: Ashish Sumant, Mountain View, CA (US); Lei Tang, Santa Clara, CA (US); Kun Liu, Sunnyvale, CA (US); Wanlin Pang, Sunnyvale, CA (US)

(73) Assignee: Yahoo! Inc., Sunnyvale, CA (US)

(21) Appl. No.: 13/397,417

(22) Filed: Feb. 15, 2012

(51) Int. Cl. G06Q 30/02

(52) U.S. Cl. 705/14.41

(57) ABSTRACT

The present invention provides techniques for use in measuring effects of social sharing, and social sharing user characteristics, on advertisement effectiveness. Measurement information can be used in many ways, such as in optimizing advertisement campaigns and advertisement targeting. Techniques are provided in which bucket testing experiments are utilized. Advertisement performance may be tracked, including downstream advertisement performance, which may follow social sharing, in measuring differences in advertisement performance between content sharing users and content non-sharing users. Techniques are provided in which user social graph information may be used in determining downstream advertisement performance, even without information regarding specific sharing instances.

### BACKGROUND

With the advent and rapidly increasing effects of social media and social sharing on such things as online advertising, targeting social influencers to optimize the effectiveness of advertising is not new. However, utilized approaches and frameworks may suffer from a host of problems. Some approaches, for example, are rigorous and academic, but may be impractical to implement. Other approaches, for example, may be insufficiently developed or not practically or sufficiently testable or verifiable in terms of their effectiveness.

There is a need for effective or improved approaches in measuring and utilizing such things as the effect of social sharing in online advertising.

### SUMMARY

Some embodiments of the invention provide systems and methods for use, for example, in measuring effects of social sharing, and social sharing user characteristics, on advertisement effectiveness. Measurement information can be used in many ways, such as in optimizing advertisement campaigns and advertisement targeting. Techniques are provided in which bucket testing experiments are utilized. Advertisement performance may be tracked, including downstream advertisement performance, which may follow social sharing, and used in measuring differences in advertisement performance between content sharing users and content non-sharing users. In some embodiments, techniques are provided in which user social graph information may be used in determining or estimating downstream advertisement performance, even without information regarding specific sharing instances.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

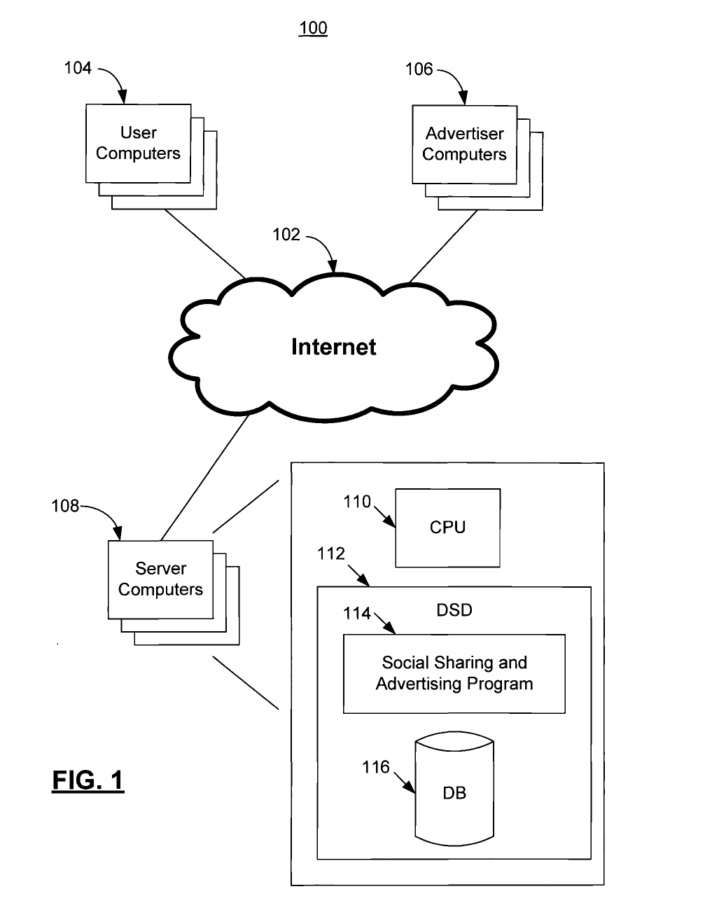

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, smart phone, PDAs, tablets, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, etc.

As depicted, each of the server computers 108 includes one or more CPUs 110 and a data storage device 112. The data storage device 112 includes a database 116 and Social Sharing and Advertising Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

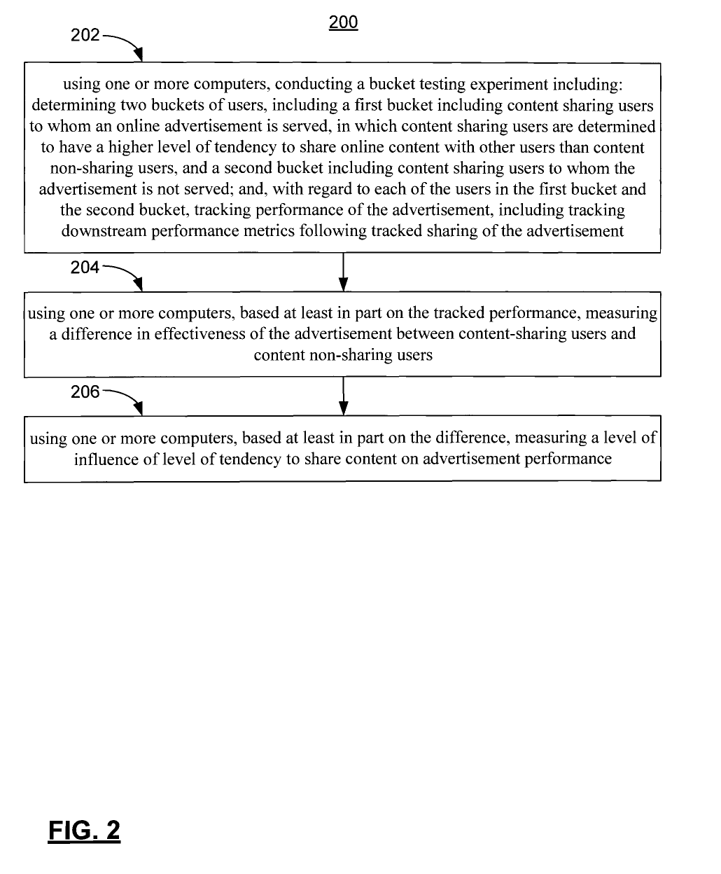

FIG. 2 is a flow diagram illustrating a method according to one embodiment of the invention. Step 202 includes, using one or more computers, conducting a bucket testing experiment. The experiment includes determining two buckets of users, including a first bucket comprising content sharing users to whom an online advertisement is served, in which content sharing users are determined to have a higher level of tendency to share online content with other users than content non-sharing users, and a second bucket including content sharing users to whom the advertisement is not served. The experiment further includes, with regard to each of the users in the first bucket and the second bucket, tracking performance of the advertisement, including tracking downstream performance metrics following tracked sharing of the advertisement.

Step 204 includes, using one or more computers, based at least in part on the tracked performance, measuring a difference in effectiveness of the advertisement between content-sharing users and content non-sharing users.

Step 206 includes, using one or more computers, based at least in part on the difference, measuring a level of influence of level of tendency to share content on advertisement performance. It is to be understood that, in various embodiments, content can take many forms, or may be limited to specific forms. For example, in some embodiments, content can be or include visual, audio or video content, news items or articles, advertisements, etc.

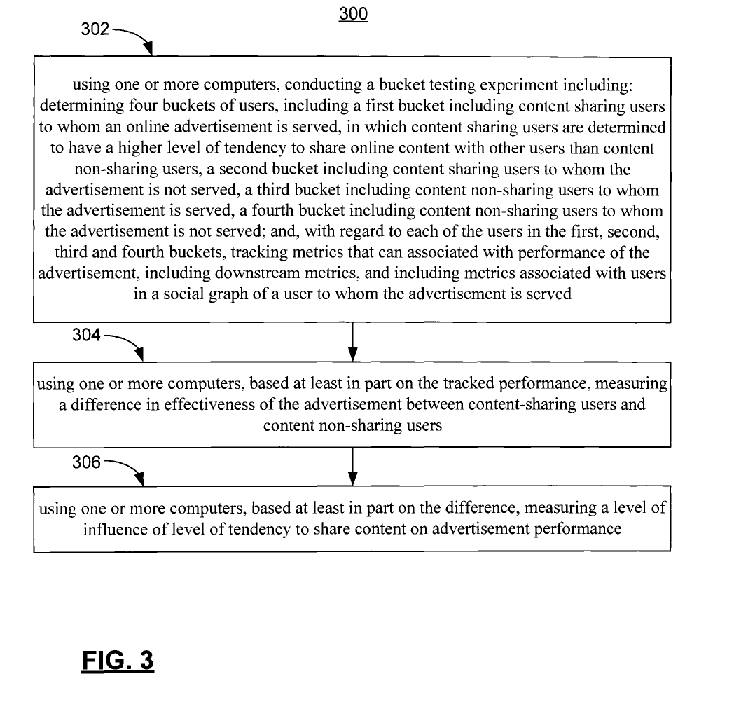

FIG. 3 is a flow diagram illustrating a method 300 according to one embodiment of the invention. Step 302 includes, using one or more computers, conducting a bucket testing experiment. The experiment includes determining four buckets of users, including a first bucket including content sharing users to whom an online advertisement is served, in which content sharing users are determined to have a higher level of tendency to share online content with other users than content non-sharing users, a second bucket including content sharing users to whom the advertisement is not served, a third bucket including content non-sharing users to whom the advertisement is served, and a fourth bucket including content non-sharing users to whom the advertisement is not served. The experiment further includes, with regard to each of the users in the first, second, third and fourth buckets, tracking metrics that can associated with performance of the advertisement, including downstream metrics, and including metrics associated with users in a social graph of a user to whom the advertisement is served. In some embodiments, for example, content non-sharers can be news non-sharers, which could be users that visit one or more news sites, but to not engage in news sharing with other users.

Step 304 includes, using one or more computers, based at least in part on the tracked performance, measuring a difference in effectiveness of the advertisement between content-sharing users and content non-sharing users.

Step 306 includes, using one or more computers, based at least in part on the difference, measuring a level of influence of level of tendency to share content on advertisement performance.

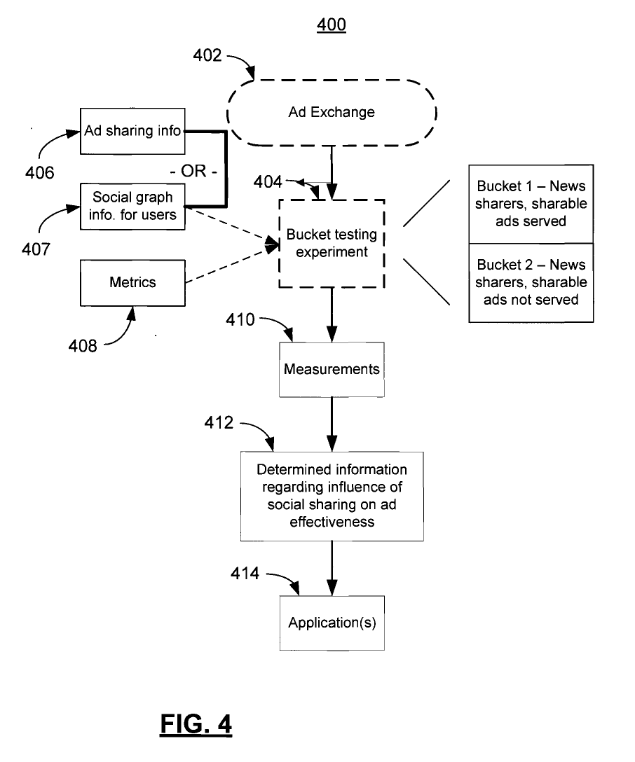

FIG. 4 is a block diagram 400 illustrating one embodiment of the invention. An advertising system, such as an exchange 402 is depicted. Block 404 represents a bucket testing experiment. Other embodiments include experimentation or testing other than bucket testing.

The experiment 404 may utilize information from the exchange 402. Additionally, whether in connection with the exchange 402, the experiment 404 utilizes advertisement sharing information 406, or may use social graph information for users 407, and metrics 408 which may be associated with advertisement performance, whether actual, estimated or hypothetical. As mentioned elsewhere herein, in some embodiments, rather than advertisement sharing information, social network overlap information may be utilized, such as if sufficient advertisement sharing information is not obtained, not available, not practically available, etc. In the embodiment depicted, two buckets are utilized. A first bucket includes users deemed to be news-sharers, to whom sharable advertisements are served, and the second bucket includes users who are deemed to be news sharers, to whom a sharable advertisement is not served. In some embodiments, new non-sharers may be, for example, users that visit a news site but do not have a history of sharing news content with other users. In some embodiments, users who are not served sharable advertisements are users who are prevented from being served sharable advertisements, or may be served something in place of the sharable advertisements, such as a public service announcement, etc. Although sharable advertisements are mentioned, in some embodiments, a sharable advertisement can be any advertisement, since advertisements of many forms can be shared in many ways, although in some embodiments, sharable advertisements may be particularly suitable for sharing, etc. In some embodiments, users in different buckets are selected to be similar in non-experimental ways, such as being from the same targeting segment, etc.

At block 410, measurements are determined based on the bucket testing experiment, such as metrics that may be associated with performance of the advertisement.

At block 412, using the measurements, information is determined regarding the influence of social sharing on advertisement effectiveness. Advertisement effectiveness generally includes, for example, any of various measures of level of achievement of the goal or goals of an advertisement, and can be any of various measures of the effectiveness of an advertisement, may be advertisement performance, may include or take into account advertisement performance, or may be associated with advertisement performance. The information can include, for example, information regarding the association between level of tendency share, or share content, on advertisement performance (including downstream performance), whether for a group or an individual user, information regarding the association between level of tendency to share advertisements, or actual sharing of advertisements, on advertisement performance, etc.

At block 414, determined information is used in one or more applications, such as in an advertisement campaign or campaign optimization, advertisement targeting or targeting optimization, etc.

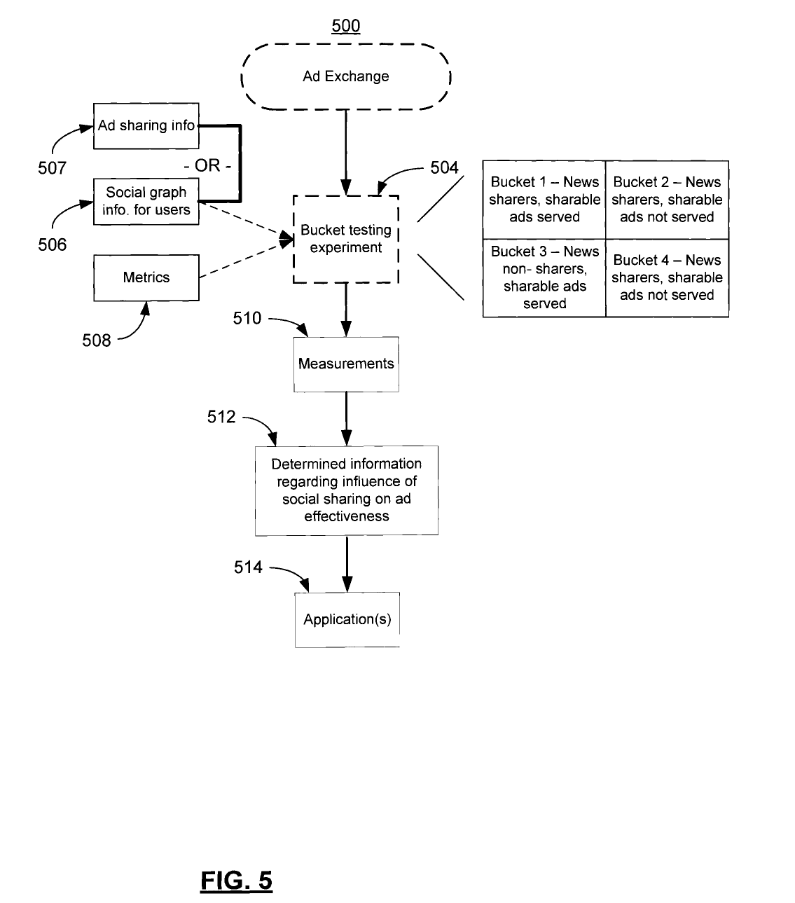

FIG. 5 is a block diagram 500 illustrating one embodiment of the invention, much of which is similar to that of FIG. 4. However, in this embodiment, four buckets are utilized in the bucket testing experiment 504. Additionally, in the embodiment depicted, it is assumed that limited or no specific information is available or utilized regarding actual sharing of the advertisement, such as between a first user served the advertisement and a second user in the social graph of the first user (an example of “one hop”, or level of sharing), between the second user and a third user in the social graph of the second user (an example of “two hops”), etc. Rather than using specific sharing information, in this embodiment, social graph information about the user served the advertisement, and others user as available or needed, is used. Metrics are obtained with respect to such users, and estimations or inferences are made regarding advertisement performance, including downstream performance.

In the embodiment depicted in FIG. 5, a first bucket includes news sharers to whom a sharable advertisement is served, a second bucket includes news sharers to whom the sharable advertisement is not served, a third bucket includes news non-sharers to whom the sharable advertisement is served, and a fourth bucket includes news non-sharers to whom the sharable advertisement is not served. In some embodiments, metrics associated with bucket two, including downstream performance metrics (associated with users in relevant social graphs), may be subtracted from metrics associated with bucket one, in order to assess advertisement performance in connection with news sharers, and similarly regarding buckets four and three, respectively, and these may be compared in assessing differences between sharers and non-sharers, etc.

As depicted in FIG. 5, inputs into the experiment 504 may include social graph information 506 for users including users to whom the advertisement is served (and perhaps other users, which may depend on the number of “hop” levels used in the experiment), or may include advertisement sharing information 507. For example, in some embodiments, if sufficient advertisement sharing information is not obtained, not available, or not practically available, then social network information and overlay information may be utilized. Additionally, metrics 508, including downstream metrics, are obtained.

At step 510, measurements are obtained.

At step 512, information is determined, including information regarding the influence of social sharing on ad effectiveness. The information can include, for example, information regarding the association between level of tendency share, or share content, on advertisement performance (including downstream performance), whether for a group or an individual user, information regarding the association between level of tendency to share advertisements, or actual sharing of advertisements, on advertisement performance, etc.

At step 514, determined information is used in one or more applications, such as in an advertising campaign or campaign optimization, advertisement targeting or targeting optimization, etc.

In some embodiments, first order metrics are obtained, such as impressions, clicks or conversions by users who are served the advertisement (a first user), as well as second or higher order metrics, such as clicks or conversions by users in the social graph of the first user, or users with whom the advertisement has been shared by the first user, etc.

In some embodiments, first order metrics can include, for example, impressions, clicks, conversions, and sharings. Second and higher order metrics can include, for example, clicks or conversions, as well as other things.

A diffusion path of an advertisement can be a path that an advertisement takes between two or more users, such as by being shared by a first user, to whom the advertisement is served, to a second user in the social graph of the first user, to a third user in, for example, the social graph of the second user, etc.

Some embodiments of the invention track the specific diffusion path and use this information in association with metrics, including downstream metrics. For example, sharing by email may be practically trackable. However, very often, diffusion path information is unavailable, unclear, imprecise, or impractical to collect. Such sharing can include many different types of communications, both online and offline, including various channels, etc., and including one-to-one as well as more widespread or group communications. For example, sharing can include communications or postings via social network sites, blogs, blog-to-blog communications, phone conversations, instant messaging, texting, email, and many other types of posting, messaging and communications. None the less, some embodiments include collection of downstream metrics, for example, by overlaying a user's social graph and tracking metrics associated with members of a user's social graph. For example, a social graph of a first user, served the advertisement, may be used to determine all or a subset of users connected to the first user socially, whether directly or by one or more degrees of separation. Metrics can then be collected on those users, users in the social graph of those users, etc. These metrics can be used in assessing the performance of an advertisement in consideration of sharing, such as if compared to similarly situated users in an instance where the advertisement was not served to the first user.

Herein, the term “social graph” is intended to broadly include, for example, users to whom a first user is socially connected. Many and varied sources can be used in constructing or updating a social graph, such as one or more social networking sites, friends lists, contacts such as IM or email contacts, buddy list, mutual followers, offline sources, and many others. Some embodiments anticipate social graphs that may be constructed from any or several of a variety of sources. Some embodiments use various techniques to verify or increase social graph accuracy, such as by ensuring at least one two-way communications between users to exclude spammers, etc.

In some embodiments, experiments can address issues such as, for example, whether content or news sharing and advertisement sharing correlated. Another addressed issue could be, if content sharing leads to a certain frequency or number downstream clicks, how does this correlate with downstream advertisement click number or frequency following advertisement sharing? Many other issues and questions can also be addressed.

Some embodiments of the invention better allow delivering the power of “word of mouth” style advertising in the online realm in a meaningful way. In some embodiments, information leveraged in this regard includes social graph information on users, such as from a variety of sources, information on user and user group sharing characteristics and tendencies, and user profiles generally. Companies both large and small seek to take advantage of social networking in sales, branding, advertising, etc.

Some embodiments of the invention, for example, identify social sharing users, who may, for example, be active is sharing content on a variety of Web properties, and measure the value and effectiveness of such users in “spreading the word” or sharing in terms of effectiveness of advertisements and campaigns. This is becoming ever more critical as the prevalence and frequency of social sharing continues to rise.

Some embodiments of the invention utilize and address various hypotheses, issues or questions. For example, some embodiments address the issue of how much users are affected or influenced by a shared advertisement? Some embodiments also observe advertisement sharing and its effect on advertisement performance, and how this is influenced by a particular user. For example, some embodiments address the issue of whether content-sharing users are more likely to share advertisements, more influential in terms of advertisement performance when they do share advertisements, etc.

In some embodiments, various types of metrics may be collected and used, directly or indirectly, in measuring influence, advertisement performance and effectiveness, etc. Such metrics can include user behavior such as clicking, conversions, etc.

Some embodiments also address issues such as what attributes influence a user's influence power in advertising. For example, some embodiments use overlay of a user's social graph with collected downstream metrics, such as clicks or conversions that can be attributed, directly or indirectly, to a user, to analyze and determine correlations in this regard, etc.

Some embodiments of the invention anticipate an experimental set up that includes precise advertisement sharing information. For example, in some embodiments, each relevant advertisement serving impression generates or displays a unique and trackable coupon number, to allow collection of metrics such as associated clicks and conversions. Furthermore, each sharing event can generate a unique and trackable coupon code for tracking downstream clicks or conversions.

Some embodiments of the invention, however, do not anticipate or require such a set up, which includes sharing event information and tracking. For example, as described herein, in some embodiments, social graphs of users are used, and downstream metrics are tracked accordingly. Database matching, techniques, for example, can be used in determining or estimating attributable conversions, etc. Such embodiments may not require diffusion information.

Some embodiments of the invention provide a qualitative and solid framework allowing measurement, for example, of the effectiveness of influence-based advertisement targeting. Some embodiments are built on well-defined statistical theory, but allow quantification of influence as a factor, even if sharing information is not available or not tracked. Furthermore, some embodiments provide a relatively simple way to identify influencers in advertising based on content sharing characteristics or history, which can include users that are more socially active or more likely to “spread the word” about certain products.

Some embodiments help bring “word of mouth” style advertising to the online world, including harnessing the power of new social medias. Some embodiments allow monetization in connection with users who are active sharers, and in connection with social networks and graphs, and can allow providing new targeting techniques and products to advertisers. Furthermore, in the science and research realm, some embodiments can provide useful raw data, such as for modeling and understanding influence.

While the invention is described with reference to the above drawings, the drawings are intended to be illustrative, and the invention contemplates other embodiments within the spirit of the invention.

1. A method comprising:
using one or more computers, conducting a bucket testing experiment comprising:
determining two buckets of users, comprising:
a first bucket comprising content sharing users to whom an online advertisement is served, wherein content sharing users are determined to have a higher level of tendency to share online content with other users than content non-sharing users; and
a second bucket comprising content sharing users to whom the advertisement is not served; and
with regard to each of the users in the first bucket and the second bucket, tracking performance of the advertisement, comprising tracking downstream performance metrics following tracked sharing of the advertisement;
using one or more computers, based at least in part on the tracked performance, measuring a difference in effectiveness of the advertisement between the first bucket and the second bucket; and
using one or more computers, based at least in part on the difference, measuring a level of influence of level of tendency to share content on advertisement performance.

2. The method of claim 1, comprising conducting the experiment, wherein the content is news.

3. The method of claim 1, comprising conducting the experiment, wherein the experiment and measurements are within a particular targeting segment of users.

4. The method of claim 1, wherein the measured level of influence is used in online advertisement campaign optimization.

5. The method of claim 1, wherein the measured level of influence is used in online advertisement targeting.

6. The method of claim 1, wherein tracking downstream performance metrics following tracked sharing of the advertisement comprises tracking sharing of the advertisement from a first user served the advertisement to at least one other user in a social network of the first user, and comprising tracking downstream performance metrics relating to the other user, and comprises tracking metrics associated with a specified number of social graph hops.

7. The method of claim 1, wherein tracking downstream performance metrics following tracked sharing of the advertisement comprises tracking metrics in relation to individual users, and comprises, with respect to an individual user, measuring advertisement performance associated with the individual user, including downstream performance, in relation to a level of tendency of the individual user to share online content with other others.

8. The method of claim 1, wherein the experiment is used in exploring how advertisement sharing affects advertisement performance.

9. The method of claim 1, wherein the experiment is used in exploring how advertisement sharing affects advertisement performance among different users and different types of users.

10. The method of claim 1, comprising targeting advertisements based at least in part on a measured level of influence of level of tendency to share content on advertisement performance, and comprising serving the advertisements to users.

11. A system comprising:
one or more server computers coupled to a network; and
one or more databases coupled to the one or more server computers;
wherein the one or more server computers are for:
conducting a bucket testing experiment comprising:
determining four buckets of users, comprising:
a first bucket comprising content sharing users to whom an online advertisement is served, wherein content sharing users are determined to have a higher level of tendency to share online content with other users than content non-sharing users;
a second bucket comprising content sharing users to whom the advertisement is not served;
a third bucket comprising content non-sharing users to whom the advertisement is served; and
a fourth bucket comprising content non-sharing users to whom the advertisement is not served; and
with regard to each of the users in the first, second, third and fourth buckets, tracking metrics that can associated with performance of the advertisement, including downstream metrics, and including metrics associated with users in a social graph of a user to whom the advertisement is served;
based at least in part on the tracked performance, measuring a difference in effectiveness of the advertisement between content-sharing users and content non-sharing users; and
using one or more computers, based at least in part on the difference, measuring a level of influence of level of tendency to share content on advertisement performance.

12. The system of claim 11, and wherein determining advertisement performance associated with content sharing users comprises subtracting bucket two measurements from bucket one measurements, and wherein determining advertisement performance associated with content non-sharing users comprises subtracting bucket four measurements from bucket three measurements.

13. The system of claim 11, with regard to each of the users in the first, second, third and fourth buckets, tracking metrics that can be associated with performance of the advertisement, including downstream metrics, and including metrics associated with users in a social graph of a user to whom the advertisement is served, and including metrics associated with a desired number of social graph hops.

14. The system of claim 11, comprising conducting the experiment, wherein the content is news.

15. The system of claim 11, wherein the measured level of influence is used in online advertisement campaign optimization.

16. The system of claim 11, wherein the measured level of influence is used in online advertisement targeting.

17. The system of claim 11, wherein the experiment is used in exploring how advertisement sharing affects advertisement performance.

18. The system of claim 11, wherein the experiment is used in exploring how advertisement sharing affects advertisement performance among different users and different types of users.

19. The system of claim 11, comprising targeting advertisements based at least in part on the measured level of influence of level of tendency to share content on advertisement performance, and comprising serving the advertisements to users.

20. A computer readable medium or media containing instructions for executing a method comprising:
using one or more computers, conducting a bucket testing experiment comprising:
determining four buckets of users, comprising:
a first bucket comprising content sharing users to whom an online advertisement is served, wherein content sharing users are determined to have a higher level of tendency to share online content with other users than content non-sharing users;
a second bucket comprising content sharing users to whom the advertisement is not served;
a third bucket comprising content non-sharing users to whom the advertisement is served; and
a fourth bucket comprising content non-sharing users to whom the advertisement is not served; and
with regard to each of the users in the first, second, third and fourth buckets, tracking metrics that can associated with performance of the advertisement, including downstream metrics, and including metrics associated with users in a social graph of a user to whom the advertisement is served;
using one or more computers, based at least in part on the tracked performance, measuring a difference in effectiveness of the advertisement between content-sharing users and content non-sharing users; and
using one or more computers, based at least in part on the difference, measuring a level of influence of level of tendency to share content on advertisement performance.
